(19) United States
(12) Patent Application Publication
(10) Pub. No.: US 2026/0056773 A1
(43) Pub. Date: Feb. 26, 2026

(54) PRESERVATION OF SERIALIZATION FOR PROCESSING OF ASYNCHRONOUS TASKS

(71) Applicant: Charter Communications Operating, LLC, St. Louis, MO (US)

(72) Inventors: Stephen Anthony Gionfriddo, Castle Rock, CO (US); Ryan Burch, Woodland Park, CO (US); Weiwen Chen, Parker, CO (US)

(21) Appl. No.: 18/811,292

(22) Filed: Aug. 21, 2024

(51) Int. Cl. G06F 9/48; G06F 9/30; G06F 9/54

(52) U.S. Cl. CPC G06F 9/4881; G06F 9/3009; G06F 9/544

(57) ABSTRACT

First message information indicative of a plurality of first ordered tasks is obtained from a message broker. The first ordered tasks are ordered based on an order in which each of the ordered tasks was received by the message broker. A first task processing hashmap is generated that maps each of a plurality of first ordered task sequences to a corresponding first task entity of a plurality of first task entities. Each of the first ordered task sequences comprises one or more of the plurality of first ordered tasks associated with the corresponding task entity and ordered based on the order in which each of the plurality of first ordered tasks was received by the message broker. The first task processing hashmap is processed to perform the plurality of ordered first task sequences.

### BACKGROUND

Asynchronous processing is a method of executing tasks in a non-blocking manner in which the process of completing one task does not “block” the completion of a different task. In turn, this allows a system to perform other operations while waiting for tasks to complete. Unlike synchronous processing, where tasks are executed sequentially and each task must wait for the previous one to finish, asynchronous processing enables multiple tasks to run concurrently. This is particularly beneficial in environments where tasks can experience delays, such as waiting for I/O operations, network responses, or user inputs. Asynchronous processing enhances the efficiency and responsiveness of applications, making it a fundamental technique in modern programming for managing tasks that can be executed independently or in parallel.

### SUMMARY

Implementations described herein are directed to preservation of serialization for processing of asynchronous tasks. For example, first message information (e.g., a set of ordered messages or tasks, etc.) indicating a plurality of ordered tasks can be obtained from a message broker. Associations between the ordered tasks and task entities (e.g., devices, systems, services, etc.) can be identified. For example, an ordered task may be associated with a task entity if the task is to provide information to the task entity. A task processing hashmap can be generated that maps task entities to respectively associated sequences of ordered tasks. The task processing hashmap can be processed to perform the ordered task sequences for each of the task entities.

One example aspect of the present disclosure is directed to a method. The method includes obtaining, by a computing system comprising one or more processor devices, first message information indicative of a plurality of first ordered tasks from a message broker, wherein the plurality of first ordered tasks are ordered based on an order in which each of the plurality of first ordered tasks was received by the message broker. The method includes generating, by the computing system, a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker. The method includes processing, by the computing system, the first task processing hashmap to perform the plurality of ordered first task sequences.

Another example aspect of the present disclosure is directed to computing device, comprising a memory. one or more processor devices coupled to the memory. The one or more processor devices are to obtain first message information indicative of a plurality of first ordered tasks from a message broker, wherein the plurality of first ordered tasks are ordered based on an order in which each of the plurality of first ordered tasks was received by the message broker. The one or more processor devices are to generate a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker. The one or more processor devices are to process the first task processing hashmap to perform the plurality of ordered first task sequences.

Another example aspect of the present disclosure is directed to a non-transitory computer-readable storage medium that includes executable instructions to cause one or more processor devices to obtain first message information indicative of a plurality of first ordered tasks from a message broker, wherein the plurality of first ordered tasks are ordered based on an order in which each of the plurality of first ordered tasks was received by the message broker. The one or more processor devices are further to generate a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker. The one or more processor devices are further to process the first task processing hashmap to perform the plurality of ordered first task sequences.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for preservation of serialization for processing asynchronous tasks according to some implementations of the present disclosure.

FIG. 2 depicts a flow chart diagram of an example method for asynchronous buffer handling according to some implementations of the present disclosure.

FIG. 3 depicts a flow chart diagram of an example method for asynchronous hashmap generation according to some implementations of the present disclosure.

FIG. 4 depicts a flow chart diagram of an example method for asynchronous hashmap processing for task completion according to some implementations of the present disclosure.

FIG. 5 is a communication flow diagram for a computing system that facilitates preservation of serialization for processing asynchronous tasks according to some implementations of the present disclosure.

FIG. 6 depicts a flow chart diagram of an example method for preservation of serialization for processing asynchronous tasks according to some implementations of the present disclosure.

FIG. 7 is a block diagram of a computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Asynchronous processing is a method of executing tasks in a non-blocking manner in which the process of completing one task does not “block” the completion of a different task. In turn, this allows a system to perform other operations while waiting for tasks to complete. Unlike synchronous processing, where tasks are executed sequentially and each task must wait for the previous one to finish, asynchronous processing enables multiple tasks to run concurrently. This is particularly beneficial in environments where tasks can experience delays, such as waiting for I/O operations, network responses, or user inputs. Asynchronous processing enhances the efficiency and responsiveness of applications, making it a fundamental technique in modern programming for managing tasks that can be executed independently or in parallel.

Multi-threaded processing is a parallel computing approach where a single process is divided into multiple threads, each capable of running concurrently. Threads are the smallest units of processing that can be managed independently by a scheduler, typically sharing the same memory space within a process. This allows for efficient communication and data exchange between threads, reducing the overhead associated with inter-process communication. Multi-threaded processing is particularly useful for tasks that can be parallelized, such as computations, data processing, and handling multiple client requests in server applications. By distributing workload across multiple threads, it maximizes the utilization of multi-core processors, leading to improved performance and faster execution times. However, it also introduces complexity, such as the need for synchronization mechanisms to manage data consistency and avoid issues like race conditions and deadlocks.

The use of client/server technologies can intrinsically introduce latency to serialized task processing (e.g., due to latency, server processing time, response time, etc.). In turn, the latency introduced by client/server technologies can make it more difficult to effectively apply asynchronous processing techniques to serialized task processing. This difficulty is exacerbated by requests that require an “order-of-operations” (OOO) be maintained (e.g., programmatically configuring a network, etc.). In such scenarios, asynchronous processing techniques can fail, leading to tasks being completed out of order.

New networking technologies have provided network engineers with the ability to configure networks dynamically based on fluctuating demand. However, these technologies require faster and more efficient task processing than prior techniques. Additionally, such technologies still require tasks to be processed in the proper sequence. It is common for system stability to be degraded when tasks are processed in the improper sequence, or if task processing is sufficiently delayed. Additionally, this system instability can lead to message brokering systems used for managing communications to become ‘backed up’ and resource constrained. As such, a technique that maintains sequential processing in a manner conducive to modern distributed processing methods (e.g., asynchronous processing) is desired.

Accordingly, implementations described herein propose preservation of serialization for processing asynchronous tasks according to some implementations of the present disclosure. More specifically, message information can be obtained from a message broker (e.g., a series of messages or requests, etc.). A “message broker” can refer to an intermediary entity that collects and manages distribution of messages. The message broker then passes a message to a consuming process. A “message,” as described herein, refers to some event or task that is passed to a consuming process. The consuming process can “consume” the message and by doing so, can perform a task.

The message information can indicate a plurality of ordered tasks. These ordered tasks can be ordered based on an order in which each of the tasks was received by the message broker. For example, if a message broker receives a message with a request to perform a reconfiguration task and a subsequent message with a request to perform a testing task, the message information can indicate that order in which the requests were received.

Tasks can be associated with “task entities. ” As described herein, a task entity refers to an entity (e.g., a user, device, system, service, process, network node, etc.) that is associated with a corresponding task in some manner. For example, a task entity may refer to an entity that receives an output produced by performance of a task, an entity that requests a task, an entity that provides an input to a task, an entity that performs a task, an entity that is the target of a task, etc.

As such, the ordered tasks indicated by the message information can be associated with corresponding task entities. The associations between the ordered tasks and the task entities can be identified. For example, if the message information indicates a task requested by a requesting entity, the requesting entity can be the task entity associated with that task. Once identified, ordered task sequences can be determined from the plurality of ordered tasks indicated by the message information.

Each ordered task sequence can be associated with a particular task entity. For example, assume that a particular task entity sent a sequence of three task requests to a message broker. The message broker can include the three task requests (in order of receipt) in the message information. The three requested tasks can then be determined to be an ordered task sequence associated with the task entity. A task processing hashmap can be generated that maps the ordered task sequences to their associated task entities.

Once generated, the task processing hashmap can be processed to perform the ordered task sequences for the corresponding task entities. While the task processing hashmap is being processed, additional message information can be received asynchronously from the message broker using a separate thread than the thread being used to process the hashmap. Another thread (or the same thread) can be used to asynchronously generate another task processing hashmap from the additional messages. In such fashion, the ordered task sequences can be performed in order of receipt to maintain serialization while asynchronously receiving and processing messages from the message broker, thus enabling asynchronous processing techniques while retaining serialization of messages.

Aspects of the present disclosure provide a number of technical effects and benefits. As one example, implementations described herein enable asynchronous processing of serialized messages while retaining serialization. In turn, asynchronous processing can substantially reduce the time required to complete tasks. As another example, implementations described herein enable message brokers to provide multiple messages in a single transaction, rather than sending multiple messages sequentially. For example, conventional message brokering techniques generally send sequences of single messages to maintain serialization for processing requests. However, by maintaining serialization at the consuming process level, the message broker is enabled to send message information that includes “batches” of ordered tasks. In turn, this can substantially increase resource efficiency, resource stability, and message delivery speed for the message broker.

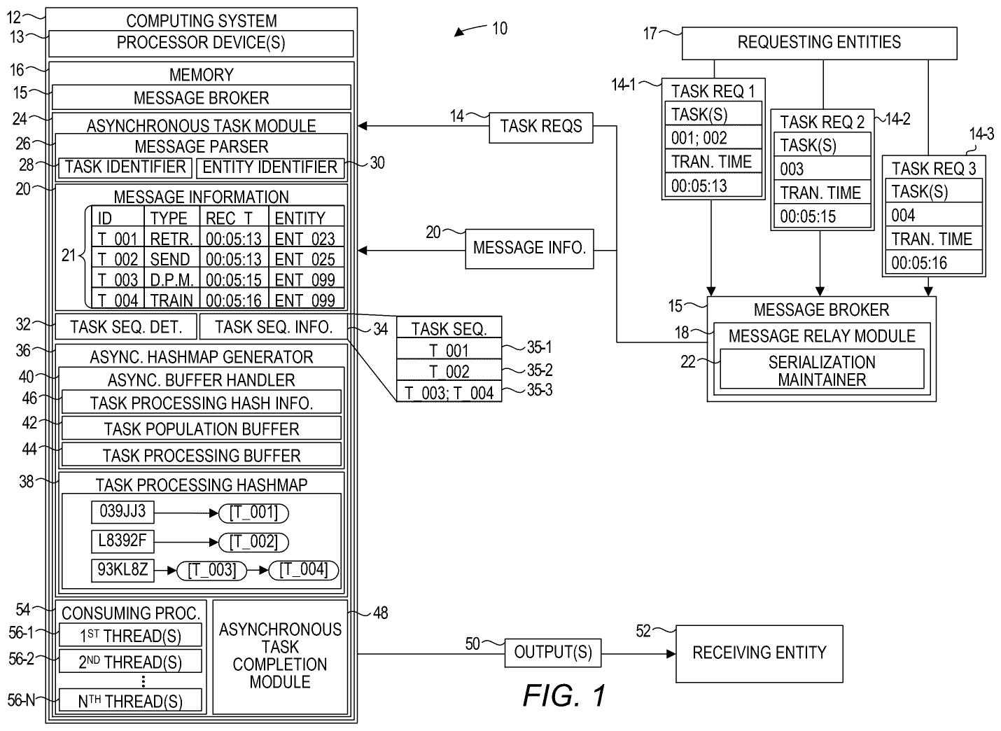

FIG. 1 is a block diagram of a computing environment 10 suitable for preservation of serialization for processing asynchronous tasks according to some implementations of the present disclosure. The computing environment 10 can include a computing system 12 with one or more processor device(s) 13 and a memory 16. In some implementations, the computing system 12 may be a computing system that includes multiple computing devices. Alternatively, in some implementations, the computing system 12 may be one or more computing devices within a computing system that includes multiple computing devices. Similarly, the processor device(s) 13 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 10 can include multiple types of nodes. As described herein, a “node” generally refers to a discrete unit of hardware and/or software resources. In some instances, nodes within the computing environment 10 can be configured to perform specific tasks. For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The computing environment 10 can include a message broker 15. In some implementations, the message broker 15 can be a service, device, node, application, virtualized entity, distributed entity, etc. that is separate from the computing system 12. Alternatively, in some implementations, the message broker 15 can be included in the memory 16 of the computing system 12 and executed with the processor device(s) 13 of the computing system 12.

The message broker 15 can collect task requests 14-1-14-3 (generally, task requests 14) from requesting entities 17. As described herein, a “task” generally refers to some processing operation (or operations) to be performed by a consuming process. A task may be as granular as performing a single READ or WRITE operation, or may refer to a higher-level task, such as searching for a data element in a dataset, that requires performance of multiple operations. It should be noted that a “task” may also be referred to as a “message”throughout in the present disclosure.

The requesting entities 17 can be any type or manner of entity, such as a process, service, application, device, system, node, etc. For example, the requesting entities 17 can include an application executed on a different computing system than the computing system 12. If the task request 14-1 is sent by the application, the task request 14-1 can be a request to retrieve information for the application, generate a rendered output for the application, perform a computation for the application, store information for the application, etc.

In some implementations, the task requests 14 can specify particular tasks to be performed by a computing system (e.g., the computing system 12, etc.). In some implementations, the message broker 15 can select the computing system 12 from a plurality of computing systems within the computing environment 10 to perform the tasks specified by the task requests 14 (e.g., when the message broker 15 is separate from the computing system 12, etc.). The computing system 12 can be selected based on resource availability (e.g., a quantity and/or type of available computing resources), a location of the computing system 12, a number of previous task requests forwarded to the computing system 12, a degree of security associated with the computing system 12, etc.

Additionally, or alternatively, in some implementations, the task requests 14 can specify certain operations, exchanges, interactions, etc. that require the performance of multiple tasks to complete. For example, assume that the task request 14-1 indicates a request to search for a particular data element in a database, and if found, modify the data element. To complete the task request 14, a computing system may be required to perform multiple operations (e.g., searching for the data element, accessing the data element, writing to the data element, etc.). In some implementations, the message broker 15 can identify a sequence of tasks required to complete a particular operation, process, request, etc. from the requesting entity.

The message broker 15 can include a message relay module 18. The message relay module 18 can generate message information 20 based on the task requests 14 received from the requesting entities 17. The message information 20 can indicate a plurality of ordered tasks 21. The message relay module 18 can send the message information 20 to the computing system 12 that will service, or complete, the tasks indicated by the task requests 14. The message relay module 18 can include a serialization maintainer 22. The serialization maintainer 22 can maintain serialization of the task requests 14 by maintaining the order in which the task requests 14 are received by the message broker 15, and indicating that order with the message information 20. For example, the task request 14-1 indicates a transmission time of 00:05:13 and the task request 14-2 indicates a transmission time of 00:05:15. The serialization maintainer 22 can generate a portion of the message information 20 which indicates that the task request 14-1 should be completed prior to completion of the task request 14-2. In such fashion, the serialization maintainer 22 can maintain serialized task processing at the system handling the tasks requested by the requesting entities 17.

The memory 16 of the computing system 12 can include an asynchronous task module 24. The asynchronous task module 24 can perform asynchronous operations to facilitate more efficient performance of serialized tasks while retaining serialization of such tasks. To do so, the asynchronous task module 24 can obtain the message information 20. As illustrated, the message information 20 can include a task identifier, a task type, a reception time (e.g., a time at which a corresponding task request was received by the message broker 15), and a task entity associated with the task.

To follow the depicted example, the task identified by the identifier T_001 can be an information retrieval type task that was received by the message broker 15 at 00:05:13 (e.g., via the task request 14-1). In some implementations, the message information 20 can identify a task entity associated with the particular task. As described herein, a task entity refers to an entity (e.g., a user, device, system, service, process, network node, etc.) that is associated with a corresponding task in some manner. For example, a task entity may refer to an entity that receives an output produced by performance of a task, an entity that requests a task, an entity that provides an input to a task, an entity that performs a task, an entity that is the target of a task, etc.

For example, the message information 20 can identify a task entity ENT_023 as being associated with the task T_001. Assume that the task entity ENT_023 is one of the requesting entities 17 that sent the task request 14-1 to the message broker 15. The message information 20 can also identify a task entity ENT_025 as being associated with the task T_002. Here, although the tasks T_001 and T_002 were included in the same task request 14-1 from a single task entity, the task entity associated with each task can be different. This can be due to differences in the type of task associated with the tasks T_001 and T_002. For instance, the task T_001 is a retrieval-type task, which indicates that an output is returned to the requesting entity (e.g., ENT_023), while the task T_002 is a storage-type task, which indicates that an output is to be written to a data store (e.g., ENT_025) separate from the requesting entity ENT_023. As such, in some implementations, the task entity associated with a task can refer to the “target” of a particular task, rather than the requesting entity (although these can be the same entity in the case of a retrieval task or the like).

In some implementations, the asynchronous task module can include a message parser 26. The message parser 26 can parse the message information 20 and, in some instances, modify the message information 20 to include supplemental information and/or to identify discrete tasks and task entities from the task requests 14. For example, assume that the message information 20 sent from the message broker 15 simply includes the task requests 14 in the order they were received at the message broker 15, and as such, does not include task identifiers or identify associated task entities. The message parser 26 can include a task identifier 28 that can identify particular tasks from the task requests 14 (e.g., identifying tasks T_001 and T_002 from the task request 14-1).

Specifically, in some implementations, the task identifier 28 can access historical task information (not illustrated) to determine a sequence of tasks associated with a particular task. For example, assume that the task request 14-1 indicates a request to retrieve a search result from a database. The historical task information can indicate that performance of multiple tasks is associated with such a request (e.g., retrieving the search result and sending an acknowledgement to a different entity). In response, the task identifier 28 can add supplemental information to the message information 20 that includes task identifiers and task types for the tasks identified from the task request 14-1.

Additionally, or alternatively, in some implementations, the message parser 26 can include an entity identifier 30 that can identify particular task entities associated with the tasks included in the message information 20. In some implementations, the entity identifier 30 can access historical entity identification information (not illustrated) to identify task entities associated with particular tasks. For example, the historical entity identification information can indicate that the task entity to be associated with a particular type of task (e.g., a retrieval task) is the “target” of that task (e.g., the entity that requested performance of the task).

The asynchronous task module 24 can include a task sequence determinator 32. The task sequence determinator 32 can generate task sequence information 34. The task sequence information 34 can identify a plurality of ordered task sequences 35-1-35-3 (generally, ordered task sequences 35). Each of the ordered task sequences 35 can include one or more tasks from the plurality of ordered tasks 21. Further, each of the ordered task sequences 35 can be associated with a particular task entity, and each of the ordered task sequences 35 can be ordered in an order of reception by the message broker 15. To follow the depicted example, the task sequence information 34 can indicate an ordered task sequence 35-1 of T_001, another ordered task sequence 35-2 of T_002, and a final ordered task sequence 35-3 of T_003 and T_004. As such, it should be noted that, in some instances, an ordered task sequence can include a single task.

The asynchronous task module 24 can include an asynchronous hashmap generator 36. The asynchronous hashmap generator 36 can generate a task processing hashmap 38. The task processing hashmap 38 maps each of the ordered task sequences 35 to a corresponding task entity of the plurality of task entities. Each of the ordered task sequences 35 can include one or more of the plurality of ordered tasks 21 associated with the corresponding task entity and ordered based on the order in which each of the plurality of ordered tasks 21 was received by the message broker. To follow the depicted example, the task processing hashmap 38 can map the ordered task sequence 35-1 to the entity represented by the hash “039JJ3” (e.g., the entity ENT_023). The task processing hashmap 38 can also map the ordered task sequence 35-2 to the entity represented by the hash “L8392F” (e.g., the entity ENT_025) and can map the final ordered task sequence 35-3 to the entity represented by the hash “93KL8Z” (e.g., the entity ENT_099). Alternatively, in some implementations, the task processing hashmap can represent task entities by their entity identifiers (e.g., ENT_023) rather than a hash value.

Hash maps associate keys with sets of values. Here, hash representations of the task entities can serve as the “keys” of the task processing hashmap 38, while the ordered task sequences 35 serve as the “values” of the hash map. As such, when a new task request 14 is received, the task request 14 can be added to the task processing hashmap 38 by first identifying the task entity associated with the requested task. Once identified, the key for that task entity can be searched for within the task processing hashmap 38. If found, the requested task can be appended to the “values” associated with that key (e.g., the ordered sequence of tasks). If the key is not found, a new key can be created for the task entity and a task sequence including the requested task can be created to serve as the “value”associated with the key.

In some implementations, the asynchronous hashmap generator 36 can include an asynchronous buffer handler 40. The asynchronous buffer handler 40 can create and maintain buffers to populate with message information received from the message broker 15. Specifically, in instances where the message broker 15 is included in the computing system 12, and/or when the message broker 15 forwards the task requests 14 directly to the computing system 12 rather than generating the message information 20, the asynchronous buffer handler 40 can populate a task population buffer 42 with the task requests 14 and/or the message information 20 prior to the asynchronous hashmap generator 36 generating the task processing hashmap 38.

For example, assume that the message broker 15 provides the task requests 14 directly to the computing system 12. The asynchronous buffer handler 40 can populate the task population buffer 42 with the task requests 14. At a particular point (e.g., when the task population buffer 42 is full, when a period of time has elapsed since the last request was received from the message broker 15, etc.), the asynchronous buffer handler 40 can copy the task population buffer 42 to a task processing buffer 44 and clear the task population buffer 42. The asynchronous hashmap generator 36 can then iterate through the task processing buffer 44 to generate the task processing hashmap 38.

In some implementations, the asynchronous buffer handler 40 can include task processing hash information 46. The task processing hash information 46 can include the same manner of information as illustrated in FIG. 1 with regards to the message information 20. For example, in some instances, the message broker 15 can generate the message information 20 based on the task requests 14, and provide the message information 20 to the computing system 12. Alternatively, in some instances, the message broker 15 can provide the task requests 14 directly to the computing system 12. In such instances, the asynchronous buffer handler 40 can generate the task processing hash information 46 from the task requests 14 as described with regards to the message information 20, and can populate the task population buffer 42 with the task processing hash information 46. As such, it should be understood that processing or pre-processing of the task requests 14 for ingestion by the computing system 12 can be performed by the message broker 15 and/or the computing system 12.

The asynchronous task module 24 can include an asynchronous task completion module 48. The asynchronous task completion module 48 can perform tasks by processing the task processing hashmap 38. In particular, the asynchronous task module 24 can perform the tasks specified by the task processing hashmap in sequential order. In some implementations, the asynchronous task completion module 48 can perform, or complete, tasks on a per-entity basis. For example, the asynchronous task completion module 48 can first search or otherwise identify the key “039JJ3” that represents the task entity “ENT_023.” The asynchronous task completion module 48 can perform the sequence of ordered tasks associated with that task entity (e.g., T_001). The asynchronous task completion module 48 can then search the key “L8392F” and perform the sequence of ordered tasks associated with that task entity (e.g., T_002).

It should be noted that the asynchronous task module 24, the asynchronous buffer handler 40, and the asynchronous task completion module 48 can each perform certain processes or operations asynchronously. For example, assume that the message broker 15 is forwarding task requests 14 from the requesting entities 17 to the computing system 12. Asynchronous processing can begin with the asynchronous buffer handler 40 processing the task requests 14 to populate the task population buffer 42 with the task processing hash information 46 (e.g., information similar to the message information 20, etc.). The asynchronous buffer handler 40 can execute this process asynchronously when the asynchronous buffer handler 40 is reading the contents of the message information 20 from the message broker 15.

Once the task population buffer 42 is populated with the task requests 14 (and/or information derived from the task requests 14, such as the task processing hash information 46 or the message information 20), the asynchronous buffer handler 40 can copy the task population buffer 42 to the task processing buffer 44 and pause to await further task request(s) from the message broker 15. Next, asynchronous processing can move to the asynchronous hashmap generator 36 processing the task processing buffer 44 to iterate over each of the task requests 14 (or information derived therefrom) in the task processing buffer 44 from oldest to newest and organizing requests for different task entities to generate the task processing hashmap 38, which leverages the key as the entity with the value represented as an array of the messages placed in order from oldest to newest for that entity maintaining the order of events for each of the requests received for the respective entity.

Once the asynchronous hashmap generator 36 has iterated through each task request included in the task processing buffer 44, the asynchronous hashmap generator 36 can pause to await further population of the task processing buffer 44. Asynchronous processing can then move to the asynchronous task completion module 48. The asynchronous task completion module 48 can process each request from oldest to newest for each task entity in the task processing hashmap 38 to complete each of the tasks requested by the task requests 14. For example, the asynchronous task completion module 48 can generate outputs 51 for receiving entities 52 by completing the requested tasks. In such fashion, implementations described herein can enable the application of asynchronous processing techniques while retaining and maintaining serialization of task requests.

In some implementations, the asynchronous task module 24 can include a consuming process 54. The consuming process 54 can refer to one or more processes that perform the operations described above. In some implementations, the consuming process 54 can refer to the asynchronous task module 24, or can otherwise facilitate operations performed by the asynchronous task module 24. In some implementations, the consuming process 54 can include threads 56-1-56-N (generally, threads 56).

The threads 56 can further increase the efficiency of asynchronous operations via multithreaded processing. For example, assume that the first thread 56-1 is used to execute the asynchronous buffer handler 40. Once the asynchronous buffer handler 42 has copied the task population buffer 42 to the task processing buffer 44 and awaits further requests, execution of the asynchronous buffer handler 40 can pause, and the first thread 56-1 can then be used to execute the asynchronous hashmap generator 36. Alternatively, in some implementations, multiple threads can be utilized in place of a single thread. For example, rather than using the first thread 56-1 to execute the asynchronous hashmap generator 36, a second thread 56-2 can be used to execute the asynchronous hashmap generator 36 while the first thread 56-1 continues execution of the asynchronous buffer handler 40.

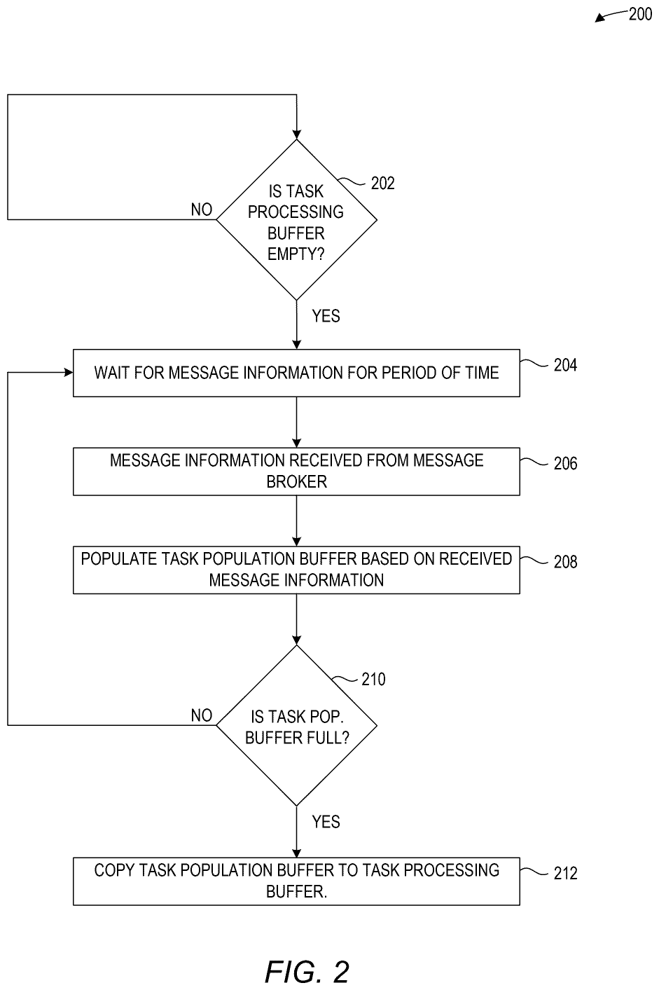

FIG. 2 depicts a flow chart diagram of an example method 200 for asynchronous buffer handling according to some implementations of the present disclosure. FIG. 2 will be discussed in conjunction with FIG. 1. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, the computing system 12, or a module implemented by the computing system 12 (e.g., the asynchronous buffer handler 40), can determine whether the task processing buffer 44 has been cleared following ingestion by the asynchronous hashmap generator 36. If the task processing buffer 44 is not clear, the computing system 12 can wait for a pre-configured period of time and then check again whether the task processing buffer is clear. If the task processing buffer 44 is clear, the computing system 12 can move to 204.

At 204, the computing system 12 can wait for a period of time for the message information 20, and/or the task requests 14, to be obtained from the message broker 15. For example, the computing system 12 may wait for a pre-configured period of time. For another example, the computing system 12 may wait until a particular quantity of the task requests 14 or the message information 20 has been received.

At 206, the computing system 12 can obtain the message information 20 from the message broker 15. In some implementations, the message information 20 can include the task requests 14. Additionally, or alternatively, in some implementations, the message information 20 can include information derived from the task requests 14. For example, if the task requests 14 each identify a particular task, the message information 20 may indicate those particular tasks while excluding metadata or other information included in the task requests 14 but not needed by the computing system 12 to complete the tasks.

At 208, the computing system 12 can populate the task population buffer 42 based on the task requests 14 and/or the message information 20. For example, the computing system 12 can asynchronously utilize the asynchronous buffer handler 40 to populate the task population buffer 42 with the task requests 14 indicated by the message information 20.

At 210, the computing system 12 can determine whether the task population buffer 42 is full. If the task population buffer 42 is not full, the computing system 12 can return to 204 to wait for additional message information from the message broker 15 for a period of time. Alternatively, if the task population buffer 42 is full, the computing system 12 can proceed to 212.

At 212, the computing system 12 can copy the task population buffer 42 (or the contents thereof) to the task processing buffer 44. The computing system 12 can then clear or otherwise remove data from the task population buffer 42.

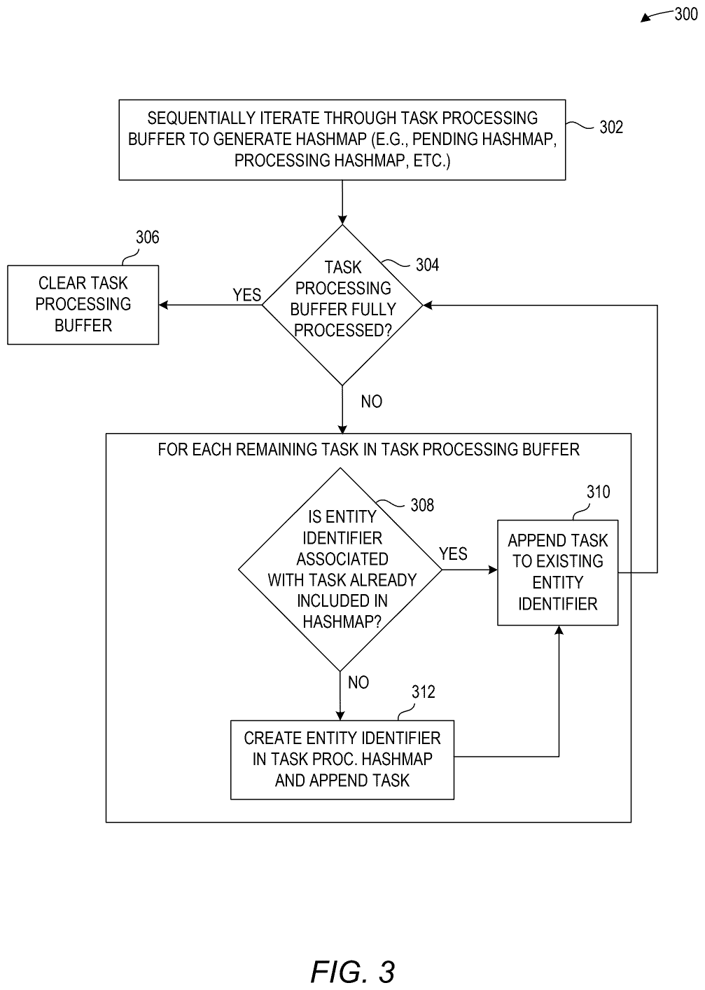

FIG. 3 depicts a flow chart diagram of an example method 300 for asynchronous hashmap generation according to some implementations of the present disclosure. FIG. 3 will be discussed in conjunction with FIG. 1. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, the computing system 12, or a module implemented by the computing system 12 (e.g., the asynchronous hashmap generator 36), can sequentially iterate through the task processing buffer 44 to generate the task processing hashmap 38.

At 304, the computing system 12 can determine whether the task processing buffer 44 has been fully processed (i.e., iterated through). If yes, the computing system 12 can clear the task processing buffer 44 at 306. If no, the computing system 12 can proceed to 308. It should be noted that performance of the operation 306 can determine whether a “NO” or “YES” is determined at operation 202 of FIG. 2.

At 308, the computing system 12 can determine, for each remaining task in the task processing buffer 44, whether an entity identifier (e.g., a hash key such as 039JJ3, an entity identifier such as “ENT_023”, etc.) exists for the task entity associated with a task. If an entity identifier already exists for the task entity within the task processing hashmap 38, the computing system 12 can proceed to 310 and append the task to the existing entity identifier. The computing system 12 can then proceed to 304.

Alternatively, if an entity identifier does not already exist for the task entity within the task processing hashmap 38, at 312 the computing system 12 can create an entity identifier (e.g., a hash key, etc.) in the task processing hashmap to 310 and append the task to the new entity identifier.

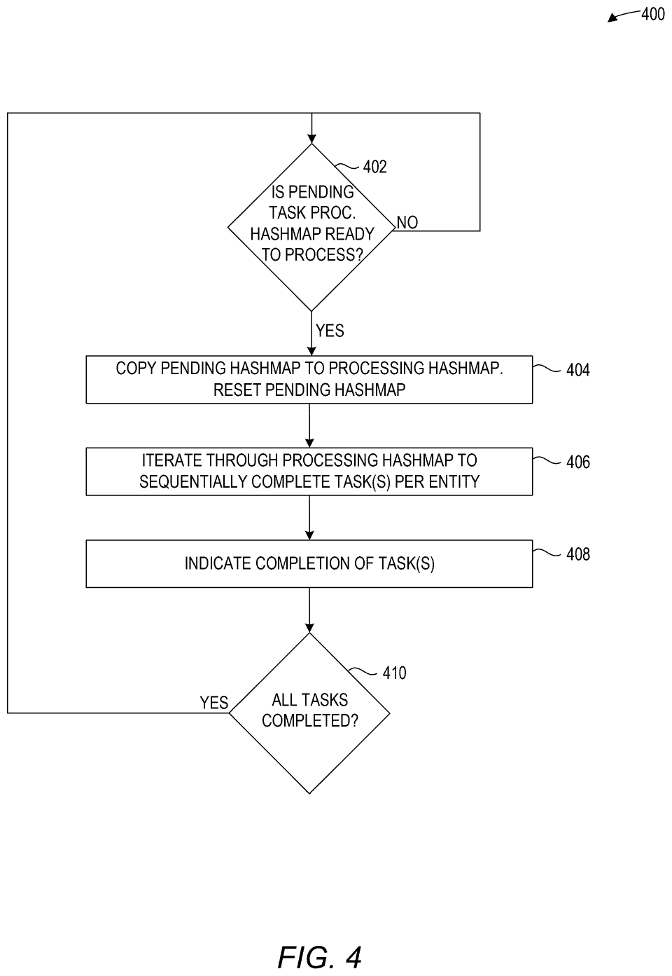

FIG. 4 depicts a flow chart diagram of an example method 400 for asynchronous hashmap processing for task completion according to some implementations of the present disclosure. FIG. 4 will be discussed in conjunction with FIG. 1. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, the computing system 12, or a module implemented by the computing system 12 (e.g., the asynchronous task completion module 48), can determine whether the task processing hashmap 38 is ready to process. In some implementations, to do so, the computing system 12 can determine that the task processing buffer 44 has been cleared by the asynchronous hashmap generator 36. If the task processing hashmap 38 is not ready to process, the computing system 12 can return to operation 402. Alternatively, if the task processing hashmap 38 is ready to process, the computing system 12 can proceed to operation 404.

In some implementations, at 404, the computing system 12 can copy the task processing hashmap 38 to a second hashmap and then process the second hashmap in the same manner as described with regards to the task population buffer 42 and the task processing buffer 44, respectively. The computing system 12 can then clear the task processing hashmap 38 and process the second hashmap. Alternatively, in some implementations, the computing system 12 can proceed directly from 402 to 406 without copying the task processing hashmap 38 to the second hashmap.

At 406, the computing system 12 can process the hashmap (e.g., the task processing hashmap 38, a second hashmap to which the task processing hashmap 38 was copied, etc.). More specifically, the computing system 12 can utilize the asynchronous task completion module 48 to iterate through the task processing hashmap 38 to sequentially complete tasks on a per-entity basis. For example, the computing system 12 can identify a first “key” in the task processing hashmap 38 that identifies a particular task entity. The computing system 12 can process each value (e.g., task) associated with the key to complete the tasks for that entity in sequential order. The computing system 12 can then sequentially identify the next key(s) in the task processing hashmap 38 and complete the tasks associated with those key(s).

At 408, the computing system 12 can indicate completion of the tasks. For example, the computing system 12 can indicate task completion to other modules of the computing system 12 (e.g., the asynchronous task module 24, etc.), the message broker 15, the receiving entity 52, the requesting entities 17, etc.

At 410, the computing system 12 can determine whether all tasks indicated by the task processing hashmap 38 have been completed. If so, the computing system 12 can return to operation 402. If not, the computing system 12 can continue to iterate through the task processing hashmap 38.

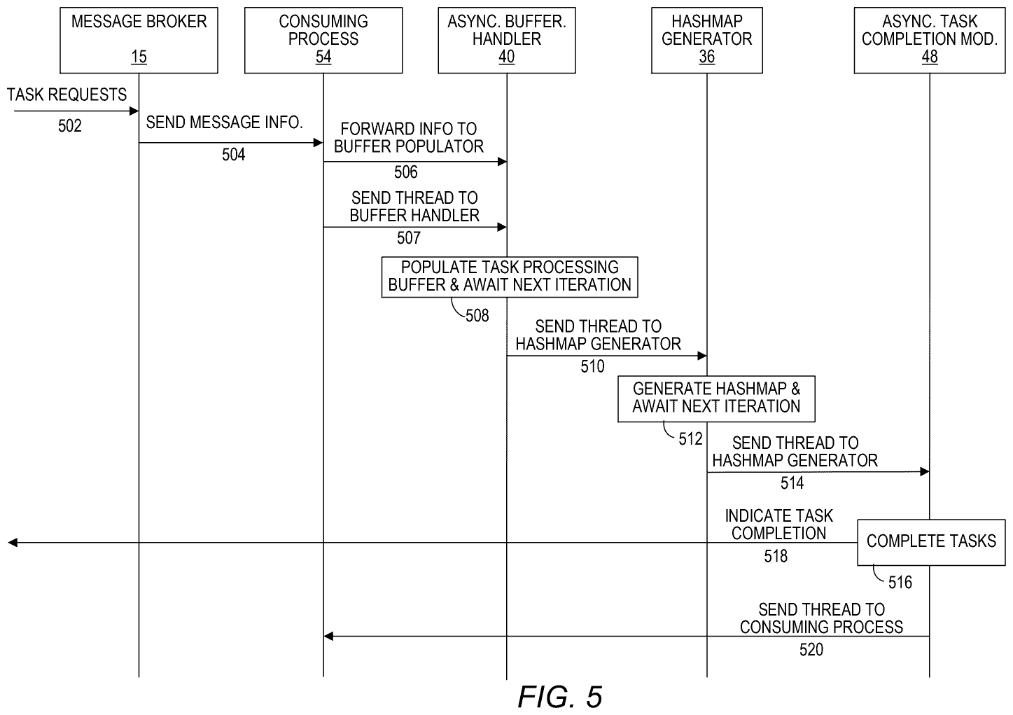

FIG. 5 is a communication flow diagram for a computing system that facilitates preservation of serialization for processing asynchronous tasks according to some implementations of the present disclosure. FIG. 5 will be discussed in conjunction with FIG. 1. In particular, at 502, the message broker 15 can obtain task requests 14 (e.g., from requesting entities 17, etc.).

At 504, the message broker 15 can send message information 20 to the consuming process 54. The consuming process 54 can be a process that is configured to ingest and process the task requests 14 received from the message broker 15 (e.g., and/or information derived from the task requests 14, such as the message information 20).

At 506, the consuming process 54 can forward the message information 20 to the asynchronous buffer handler 40. Assume that the consuming process 54 includes, or is implemented using a particular thread. At 507, the consuming process 54 can asynchronously “send” the particular thread to implement or otherwise facilitate the asynchronous buffer handler 40.

At 508, the asynchronous buffer handler 40 can populate the task processing buffer 44 and await additional message information from the consuming process 54. For example, the asynchronous buffer handler 40 can iteratively populate the task population buffer 42, and then copy the task population buffer 42 to the task processing buffer 44 once the task population buffer 42 is full.

At 510, the asynchronous buffer handler 40 can asynchronously “send” the particular thread to implement or otherwise facilitate the asynchronous hashmap generator 36. At 512, the asynchronous hashmap generator 36 can generate the task processing hashmap 38 and await the next iteration. At 514, the asynchronous hashmap generator 36 can send the particular thread to the asynchronous task completion module 48.

At 516, the asynchronous task completion module 48 can complete the tasks indicated by the task processing hashmap 38 as described with regards to FIG. 1. At 518, in some implementations, the asynchronous task completion module 48 can indicate task completion as described with regards to FIG. 1. Additionally, or alternatively, at 520, the asynchronous task completion module 48 can send the particular thread back to the consuming process 54.

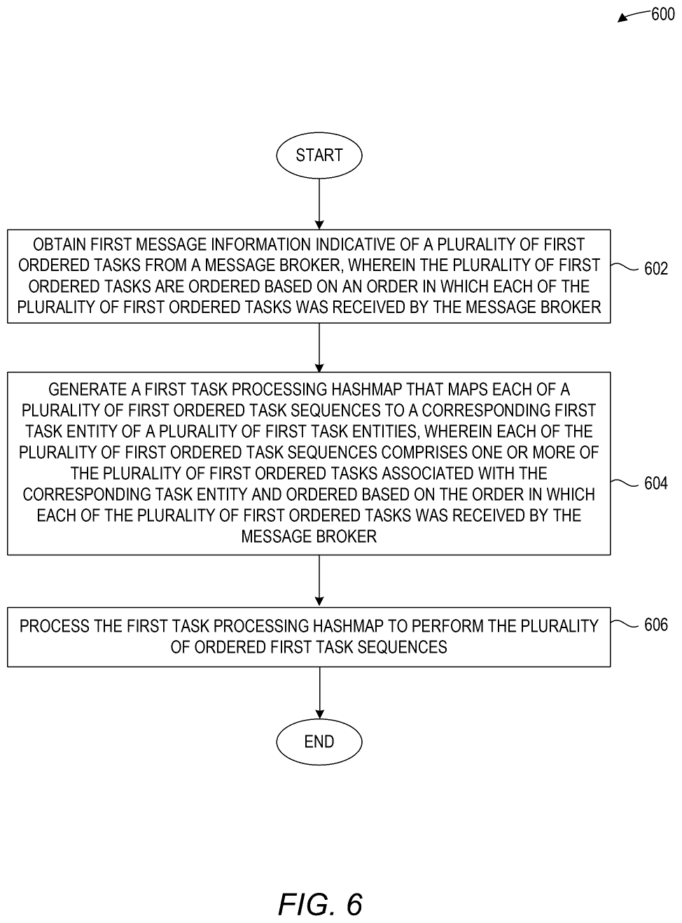

FIG. 6 depicts a flow chart diagram of an example method 600 for preservation of serialization for processing asynchronous tasks according to some implementations of the present disclosure. FIG. 6 will be discussed in conjunction with FIG. 1. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain first message information indicative of a plurality of first ordered tasks from a message broker. The plurality of first ordered tasks are ordered based on an order in which each of the plurality of first ordered tasks was received by the message broker.

In some implementations, to obtain the first message information indicative of the plurality of first ordered tasks from the message broker, the computing system can receive a plurality of messages from the message broker. The plurality of messages are ordered based on an order in which each of the plurality of first ordered tasks was received by the message broker. Based on the plurality of messages, the computing system can generate the first message information indicative of the plurality of first ordered tasks, wherein each of the plurality of messages is descriptive of at least one of the plurality of first ordered tasks.

At 604, the computing system can generate a first task processing hashmap that maps each of a plurality of first ordered task sequences to a corresponding first task entity of a plurality of first task entities. Each of the plurality of first ordered task sequences comprises one or more of the plurality of first ordered tasks associated with the corresponding task entity and ordered based on the order in which each of the plurality of first ordered tasks was received by the message broker.

At 606, the computing system can process the first task processing hashmap to perform the plurality of ordered first task sequences.

In some implementations, the computing system can obtain second message information indicative of a plurality of second ordered tasks from the message broker. The plurality of second ordered tasks can be ordered based on the order in which each of the plurality of second ordered tasks was received by the message broker. The computing system can generate a second task processing hashmap that maps each of a plurality of second ordered task sequences to a corresponding second task entity of a plurality of second task entities. Each of the plurality of ordered first task sequences includes one or more of the plurality of first ordered tasks associated with the corresponding task entity and ordered based on the order in which each of the plurality of first ordered tasks was received by the message broker. For each second ordered task sequence of the plurality of second ordered task sequences, the computing system can process the second task processing hashmap to perform the one or more second tasks of the second ordered task sequence in the order in which each of the plurality of second ordered tasks was received by the message broker.

In some implementations, to obtain the first message information, the computing system can obtain the first message information indicative of the plurality of first ordered tasks from the message broker. The first message information assigns the plurality of first ordered tasks to a consuming process executed by the computing device. Processing the first task processing hashmap to perform the plurality of first ordered task sequences can include, based on the first task processing hashmap, performing each of the plurality of first ordered task sequences with a first thread of the consuming process.

In some implementations, to generate the first task processing hashmap that maps each of the plurality of first ordered task sequences to the corresponding first task entity of the plurality of first task entities, the computing system can process the first message information to obtain task processing hash information. The computing system can store the task processing hash information to a task population buffer. The computing system can write the task processing hash information from the task population buffer to a task processing buffer to obtain the first task processing hashmap.

In some implementations, to write the task processing hash information from the task population buffer to the task processing buffer further, the computing system can remove the task processing hash information from the task population buffer.

In some implementations, the computing system can process the first message information with one or more second threads of the consuming process to obtain the task processing hash information. The one or more second threads are different than the first thread. The first thread and the one or more second threads can execute asynchronously.

In some implementations, to process the first message information with the one or more second threads to obtain the task processing hash information, the computing system can identify, with the one or more second threads, the plurality of first task entities based on the first message information. For each first task entity of the plurality of first task entities, the computing system can select, with the one or more second threads, one or more tasks from the plurality of first ordered tasks based on an association between the one or more tasks and the first task entity. The computing system can order, with the one or more second threads, the one or more tasks to obtain the first ordered task sequence mapped to the first task entity of the plurality of first ordered task sequences.

In some implementations, to select the one or more tasks from the plurality of first ordered tasks based on the association between the one or more tasks and the first task entity, the computing system can, for each task of the one or more tasks, process a portion of the first message information indicative of the task with the one or more second threads to identify an identifier associated with the first task entity.

In some implementations, the computing system can execute an asynchronous multithreaded process, wherein executing the asynchronous multithreaded process comprises performing each of the plurality of first ordered task sequences with the first thread of the consuming process, and obtaining the second message information indicative of the plurality of second ordered tasks from the message broker with a second thread X of the one or more second threads of the consuming process. In some implementations, the computing system can generate the second task processing hashmap with a second thread Y of the one or more second threads of the consuming process different than the second thread X. The computing system can process the second task processing hashmap with the first thread to perform the one or more second tasks of the second ordered task sequence.

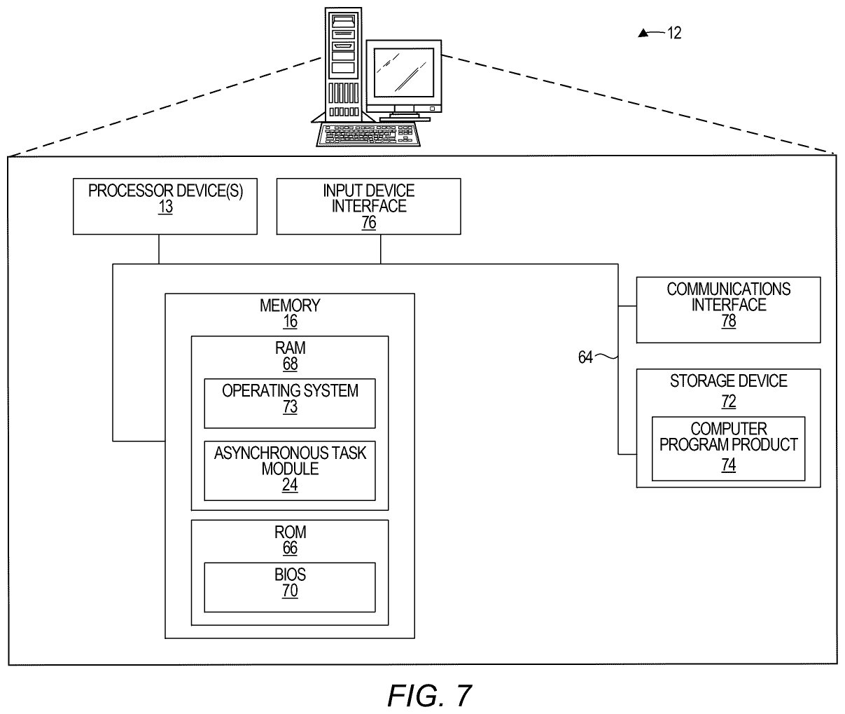

FIG. 7 is a block diagram of a computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 13, the memory 16, and a system bus 64. The system bus 64 provides an interface for system components including, but not limited to, the memory 16 and the processor device(s) 13. The processor device(s) 13 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing system 12. The volatile memory 68 may also include a high-speed RAM, such as static RAM, for caching data.

The computing system 12 may further include or be coupled to a non-transitory computer-readable storage medium such as the storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 73 and one or more program modules, such as the asynchronous task module 24, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device(s) 13 to carry out the steps described herein. Thus, the computer-readable program code can comprise software instructions for implementing the functionality of the examples described herein when executed on the processor device(s) 13. The processor device(s) 13, in conjunction with the asynchronous task module 24 in the volatile memory 68, may serve as a controller, or control system, for the computing system 12 that is to implement the functionality described herein.

Because the asynchronous task module 24 is a component of the computing system 12, functionality implemented by the asynchronous task module 24 may be attributed to the computing system 12 generally. Moreover, in examples where the asynchronous task module 24 comprises software instructions that program the processor device(s) 13 to carry out functionality discussed herein, functionality implemented by the asynchronous task module 24 may be attributed herein to the processor device(s) 13.

An operator, such as the user, may also be able to enter one or more configuration commands through a keyboard (not illustrated), a pointing device such as a mouse (not illustrated), or a touch-sensitive surface such as a display device. Such input devices may be connected to the processor device(s) 13 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 78 suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a computing system comprising one or more processor devices, first message information indicative of a plurality of first ordered tasks from a message broker, wherein the plurality of first ordered tasks are ordered based on an order in which each of the plurality of first ordered tasks was received by the message broker;
generating, by the computing system, a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker; and
processing, by the computing system, the first task processing hashmap to perform the plurality of ordered first task sequences.

2. The method of claim 1, further comprising:
obtaining, by the computing system, second message information indicative of a plurality of second ordered tasks from the message broker, wherein the plurality of second ordered tasks are ordered based on the order in which each of the plurality of second ordered tasks was received by the message broker;
generating, by the computing system, a second task processing hashmap that maps each of a plurality of second ordered task sequences to a corresponding second task entity of a plurality of second task entities, wherein each of the plurality of ordered first task sequences comprises one or more of the plurality of first ordered tasks associated with the corresponding task entity and ordered based on the order in which each of the plurality of first ordered tasks was received by the message broker; and
for each second ordered task sequence of the plurality of second ordered task sequences, processing, by the computing system, the second task processing hashmap to perform the one or more second tasks of the second ordered task sequence in the order in which each of the plurality of second ordered tasks was received by the message broker.

3. The method of claim 2, wherein obtaining the first message information indicative of the plurality of first ordered tasks from the message broker comprises:
obtaining, by the computing system, the first message information indicative of the plurality of first ordered tasks from the message broker, wherein the first message information assigns the plurality of first ordered tasks to a consuming process executed by the computing system; and
wherein processing the first task processing hashmap to perform the plurality of first ordered task sequences comprises:
based on the first task processing hashmap, performing, by the computing system, each of the plurality of first ordered task sequences with a first thread of the consuming process.

4. The method of claim 3, wherein generating the first task processing hashmap that maps each of the plurality of first ordered task sequences to the corresponding first task entity of the plurality of first task entities comprises:
processing, by the computing system, the first message information to obtain task processing hash information;
storing, by the computing system, the task processing hash information to a task population buffer; and
writing, by the computing system, the task processing hash information from the task population buffer to a task processing buffer to obtain the first task processing hashmap.

5. The method of claim 4, wherein writing the task processing hash information from the task population buffer to the task processing buffer further comprises:
removing, by the computing system, the task processing hash information from the task population buffer.

6. The method of claim 4, wherein processing the first message information to obtain the task processing hash information comprises:
processing, by the computing system, the first message information with one or more second threads of the consuming process to obtain the task processing hash information, wherein the one or more second threads are different than the first thread, and wherein the first thread and the one or more second threads execute asynchronously.

7. The method of claim 6, wherein processing the first message information with the one or more second threads to obtain the task processing hash information comprises:
identifying, by the computing system with the one or more second threads, the plurality of first task entities based on the first message information; and
for each first task entity of the plurality of first task entities:
selecting, by the computing system with the one or more second threads, one or more tasks from the plurality of first ordered tasks based on an association between the one or more tasks and the first task entity; and
ordering, by the computing system with the one or more second threads, the one or more tasks to obtain the first ordered task sequence mapped to the first task entity of the plurality of first ordered task sequences.

8. The method of claim 7, wherein selecting the one or more tasks from the plurality of first ordered tasks based on the association between the one or more tasks and the first task entity comprises:
for each task of the one or more tasks, processing, by the computing system with the one or more second threads, a portion of the first message information indicative of the task to identify an identifier associated with the first task entity.

9. The method of claim 6, wherein the method comprises:
executing, by the computing system, an asynchronous multithreaded process, wherein executing the asynchronous multithreaded process comprises:
performing, by the computing system, each of the plurality of first ordered task sequences with the first thread of the consuming process; and
obtaining, by the computing system, the second message information indicative of the plurality of second ordered tasks from the message broker with a second thread X of the one or more second threads of the consuming process.

10. The method of claim 9, wherein executing the asynchronous multithreaded process further comprises:
generating, by the computing system, the second task processing hashmap with a second thread Y of the one or more second threads of the consuming process different than the second thread X; and
processing, by the computing system, the second task processing hashmap with the first thread to perform the one or more second tasks of the second ordered task sequence.

11. The method of claim 1, wherein obtaining the first message information indicative of the plurality of first ordered tasks from the message broker comprises:
receiving, by the computing system, a plurality of messages from the message broker, wherein the plurality of messages are ordered based on an order in which each of the plurality of first ordered tasks was received by the message broker; and
based on the plurality of messages, generating, by the computing system, the first message information indicative of the plurality of first ordered tasks, wherein each of the plurality of messages is descriptive of at least one of the plurality of first ordered tasks.

12. A computing device, comprising:
a memory; and
one or more processor devices coupled to the memory to:
obtain first message information indicative of a plurality of first ordered tasks from a message broker, wherein the plurality of first ordered tasks are ordered based on an order in which each of the plurality of first ordered tasks was received by the message broker;
generate a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker; and
process the first task processing hashmap to perform the plurality of ordered first task sequences.

13. The computing device of claim 12, wherein the one or more processor devices are further to:
obtain second message information indicative of a plurality of second ordered tasks from the message broker, wherein the plurality of second ordered tasks are ordered based on the order in which each of the plurality of second ordered tasks was received by the message broker;
generate a second task processing hashmap that maps each of a plurality of second ordered task sequences to a corresponding second task entity of a plurality of second task entities, wherein each of the plurality of ordered first task sequences comprises one or more of the plurality of first ordered tasks associated with the corresponding task entity and ordered based on the order in which each of the plurality of first ordered tasks was received by the message broker; and
for each second ordered task sequence of the plurality of second ordered task sequences, process the second task processing hashmap to perform the one or more second tasks of the second ordered task sequence in the order in which each of the plurality of second ordered tasks was received by the message broker.

14. The computing device of claim 13, wherein, to obtain the first message information indicative of the plurality of first ordered tasks from the message broker, the one or more processor devices are to:
obtain the first message information indicative of the plurality of first ordered tasks from the message broker, wherein the first message information assigns the plurality of first ordered tasks to a consuming process executed by the computing device; and
wherein, to process the first task processing hashmap to perform the plurality of first ordered task sequences, the one or more processor devices are to:
based on the first task processing hashmap, perform each of the plurality of first ordered task sequences with a first thread of the consuming process.

15. The computing device of claim 14, wherein, to generate the first task processing hashmap that maps each of the plurality of first ordered task sequences to the corresponding first task entity of the plurality of first task entities, the one or more processor devices are to:
process the first message information to obtain task processing hash information;
store the task processing hash information to a task population buffer; and
write the task processing hash information from the task population buffer to a task processing buffer to obtain the first task processing hashmap.

16. The computing device of claim 15, wherein, to write the task processing hash information from the task population buffer to the task processing buffer, the one or more processor devices are further to:
remove the task processing hash information from the task population buffer.

17. The computing device of claim 15, wherein, to process the first message information to obtain the task processing hash information, the one or more processor devices are further to:
process the first message information with one or more second threads of the consuming process to obtain the task processing hash information, wherein the one or more second threads are different than the first thread, and wherein the first thread and the one or more second threads execute asynchronously.

18. The computing device of claim 17, wherein, to process the first message information with the one or more second threads to obtain the task processing hash information, the one or more processor devices are to:
identify, with the one or more second threads, the plurality of first task entities based on the first message information; and
for each first task entity of the plurality of first task entities:
select, with the one or more second threads, one or more tasks from the plurality of first ordered tasks based on an association between the one or more tasks and the first task entity; and
order, with the one or more second threads, the one or more tasks to obtain the first ordered task sequence mapped to the first task entity of the plurality of first ordered task sequences.

19. The computing device of claim 18, wherein, to select the one or more tasks from the plurality of first ordered tasks based on the association between the one or more tasks and the first task entity, the one or more processor devices are to:
for each task of the one or more tasks, process, with the one or more second threads, a portion of the first message information indicative of the task to identify an identifier associated with the first task entity.

20. A non-transitory computer-readable storage medium that includes executable instructions to cause one or more processor devices to:
obtain first message information indicative of a plurality of first ordered tasks from a message broker, wherein the plurality of first ordered tasks are ordered based on an order in which each of the plurality of first ordered tasks was received by the message broker;
generate a first task processing hashmap that maps each of a plurality of first ordered task sequences to a corresponding first task entity of a plurality of first task entities, wherein each of the plurality of first ordered task sequences comprises one or more of the plurality of first ordered tasks associated with the corresponding task entity and ordered based on the order in which each of the plurality of first ordered tasks was received by the message broker; and
process the first task processing hashmap to perform the plurality of ordered first task sequences.
